(19) United States
(12) Patent Application Publication
(10) Pub. No.: US 2020/0216189 A1
(43) Pub. Date: Jul. 9, 2020

(54) DISPLAY SYSTEM

(71) Applicant: Bell Textron Inc., Fort Worth, TX (US)

(72) Inventors: Richard Carnes, Arlington, TX (US); Samuel Bryk, Fort Worth, TX (US)

(73) Assignee: Bell Textron Inc., Fort Worth, TX (US)

(21) Appl. No.: 16/733,243

(22) Filed: Jan. 3, 2020

Related U.S. Application Data
(60) Provisional application No. 62/788,133, filed on Jan. 3, 2019.

(51) Int. Cl. B64D 43/00; B64D 47/08; B64D 11/00; B64D 11/06

(52) U.S. Cl. CPC B64D 43/00; B64D 11/0689; B64D 11/0015; B64D 47/08

(57) ABSTRACT

A display system for an aircraft includes a plurality of displays. The displays are configured to display a predetermined content in response to which of a piloted mode and an autonomous mode the aircraft is operating.

### CROSS-REFERENCE TO RELATED APPLICATIONS

This application claims priority to U.S. Provisional Patent Application No. 62/788,133, filed on Jan. 3, 2019 by Richard Carnes, et al., and titled “Display System,” the disclosure of which is incorporated by reference in its entirety.

### STATEMENT REGARDING FEDERALLY SPONSORED RESEARCH OR DEVELOPMENT

Not applicable.

### BACKGROUND

Some aircraft can operate in a piloted mode and an autonomous mode. The pilots and/or passengers can have interest in a variety of display content, depending on what mode the aircraft is operating in. Conventional display systems offer a single type of display content that is usually related to controlling the operation of the aircraft and which may not be of interest to anyone other than a pilot.

### BRIEF DESCRIPTION OF THE DRAWINGS

FIG. 1 is an oblique view of an aircraft comprising a display system according to this disclosure.

FIG. 2 is a front view of the aircraft of FIG. 1.

FIG. 3 is an oblique view looking forward within a cabin of the aircraft of FIG. 1.

FIG. 4 is an oblique view of a seat layout of the aircraft of FIG. 1

FIG. 5 is an oblique view of ceiling displays of a cabin of the aircraft of FIG. 1.

FIG. 6 is a flowchart of a method of operating a display system.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

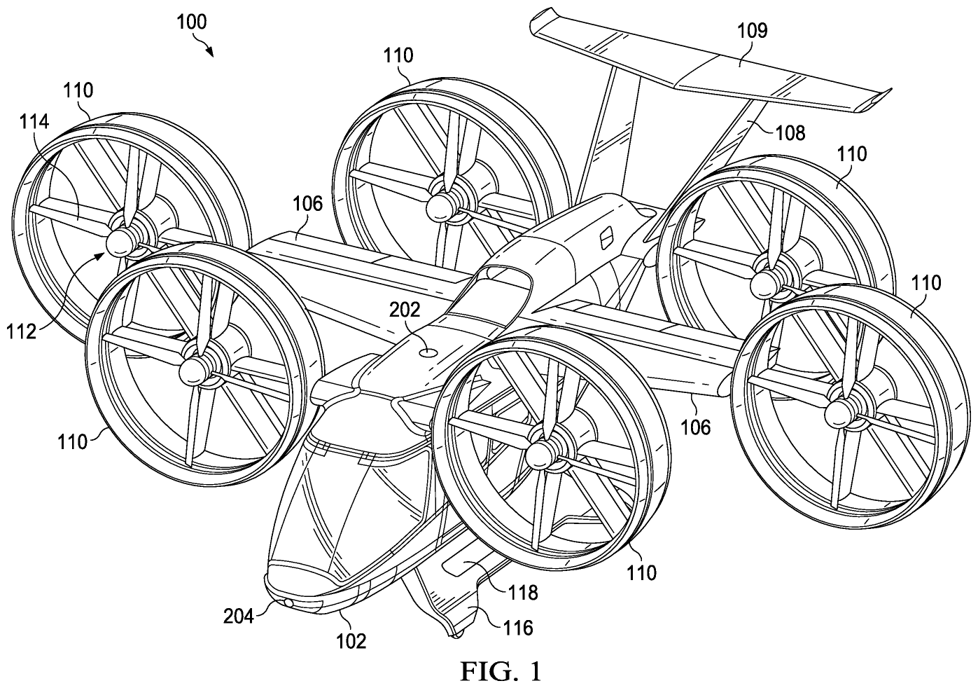

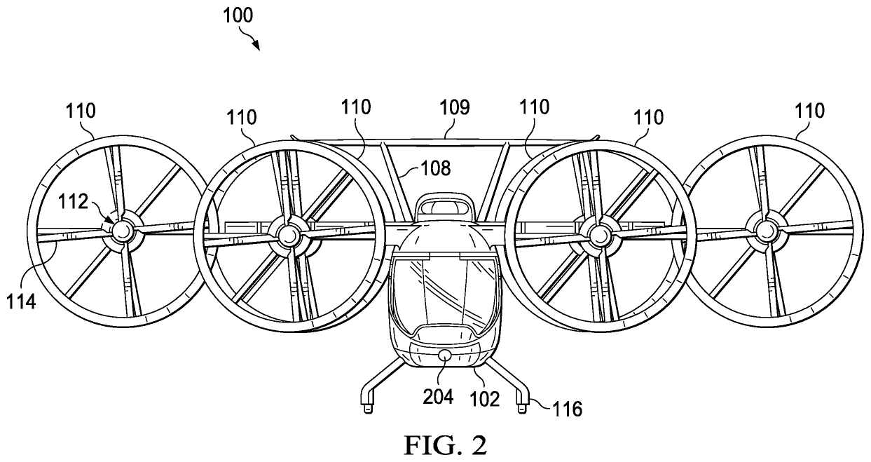

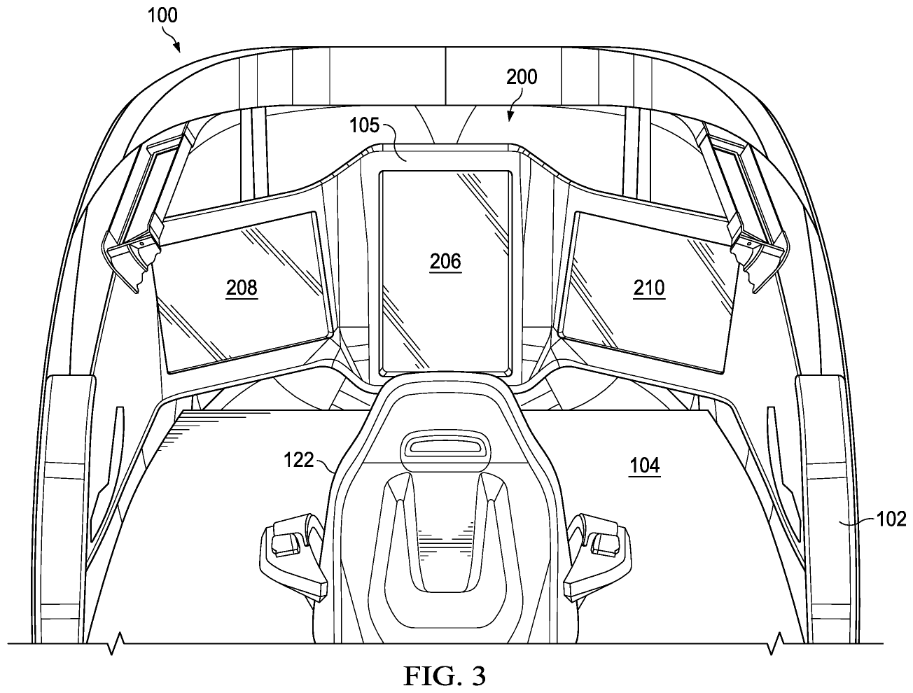

Referring now to FIGS. 1-5 an aircraft 100 according to this disclosure is shown. Aircraft 100 is generally configured as a vertical takeoff and landing (VTOL) aircraft that is operable in an airplane mode associated with forward flight and a helicopter mode associated with vertical takeoff from and landing to a landing zone. Aircraft 100 comprises a fuselage 102, a cabin 104, a plurality of wings 106 extending from the fuselage 102, and an empennage 108 having a horizontal stabilizer 109. Aircraft 100 also comprises a plurality of ducted fans 110 that may be selectively rotated with respect to the fuselage 102 in order to transition the aircraft 100 between the airplane mode and the helicopter mode.

Each ducted fan comprises a rotor system 112 having a plurality of selectively rotatable rotor blades 114 configured to generate thrust when selectively rotated in each of the airplane mode and the helicopter mode. In the embodiment shown, aircraft 100 comprises six ducted fans 110. Two ducted fans 110 are carried by, supported by and/or otherwise coupled to the fuselage 102, two ducted fans 110 are coupled to the wings 106, and two ducted fans 110 are carried by, supported by, and/or otherwise coupled to the empennage 108. However, in alternative embodiments, any number of ducted fans 110 may be used depending on the configuration and design of the aircraft. Aircraft 100 also comprises a landing gear 116 configured to support aircraft 100 when not in flight. Additionally, landing gear 116 comprises an auxiliary folding step system 118 for use by occupants entering and exiting aircraft 100. The aircraft 100 further comprises a display system 200. The display system 200 is configured to display different content as a function of user preference selections and as a function of whether the aircraft 100 is being operated in a piloted mode or an autonomous mode.

The display system 200 comprises a plurality of cameras directed away from the aircraft 100 and a plurality of displays (display screens and/or touchscreens). More specifically, the display system 200 comprises an upwardly directed camera 202 and a forward directed camera 204. The cameras 202, 204 can comprise wide angle lenses so that a large field of view is made available to the display system 200 from each camera 202, 204.

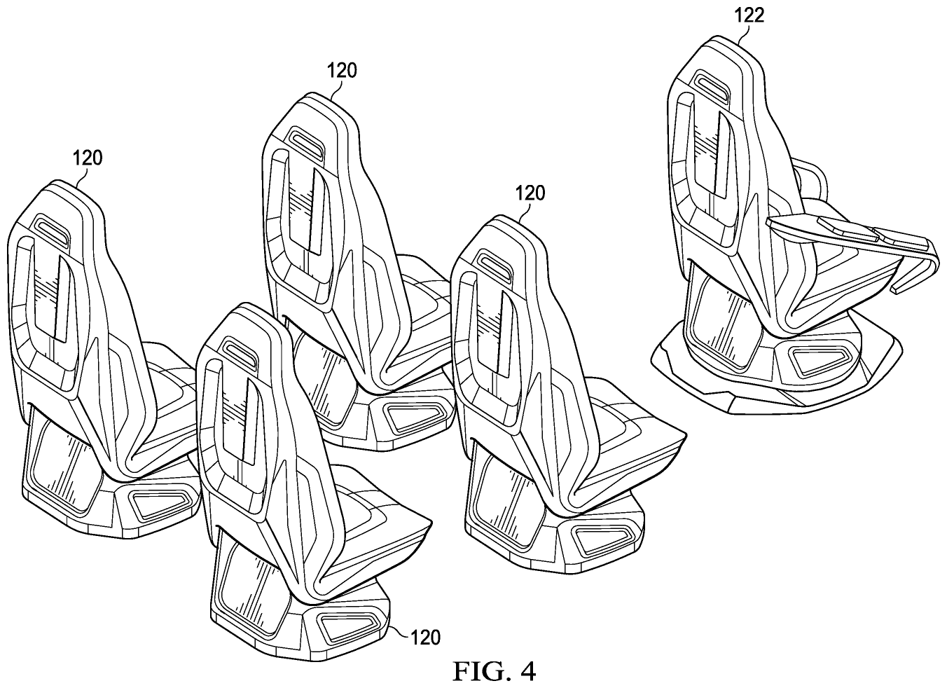

Referring to FIG. 4, a seat layout for the aircraft 100 is shown. The seat layout comprises four passenger seats 120 and a pilot seat 122. Most generally, the pilot seat 122 is located within the cabin 104 for convenient and ergonomic viewing and optionally interacting with each of a center display 206, a left display 208, and a right display 210 that are each carried within a dash 105 of the cabin 104.

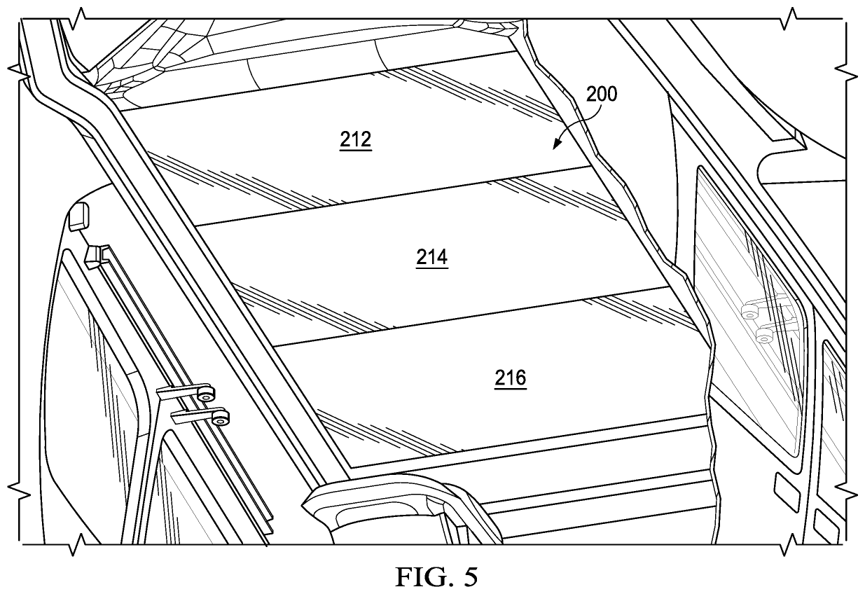

Referring now to FIG. 5, an interior view of the passenger area of the cabin 104 is shown with the perspective being one that looks up to a ceiling of the cabin 104 from near a floor of the cabin 104. From this perspective, multiple independently controllable ceiling display panels 212, 214, 216 can be seen. While the seats 120 are not shown in FIG. 5, it will be appreciated that the ceiling display panels 212, 214, 216 are generally disposed within reach of one or more of passengers that sit in seats 120. In some cases, the ceiling display panels 212, 214, 216 are touchscreens capable of receiving touch input from passengers.

The display system 200 is generally preprogrammed to display particular content dependent upon which mode the aircraft 100 is being operated in. More specifically, the display system 200 is configured to operate in a piloted display mode when the aircraft 100 is being operated in a piloted mode and the display system 200 is configured to operate in an autonomous display mode when the aircraft 100 is being operated in an autonomous mode. Nonetheless, in this embodiment, the display system 200 can be directed by user inputs to display content that is not the standard content or on a display 206, 208, 210, 212, 214, 216 that would otherwise not occur in the piloted display mode or the autonomous display mode.

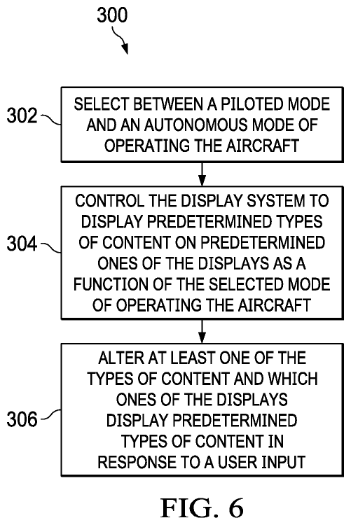

Referring now to FIG. 6, a flowchart of a method 300 of controlling a display system 200 is shown. At block 302, the method can begin by selecting between operating the aircraft in a piloted mode of operation and an autonomous mode of operation. The method can continue at block 304 by, in response to the selected mode of operating the aircraft, displaying a predetermined type of content on predetermined ones of the displays. The method can continue at block 306 by, in response to a user input, altering at least one of the types of content and which ones of the displays display predetermined types of content. In other words, while the display system 200 can be configured to initially predictably display a particular type of content on particular ones of the screens in a specific mode of operating the aircraft, the users are allowed to alter the content displayed on one or more of the displays by providing user inputs.

In one example, a selection may be made to operate the aircraft 100 in a piloted mode of operation. Accordingly, the display system 200 may operate in a piloted display mode. In the piloted display mode, each of the center display 206, left display 208, and right display 210 can be automatically configured to display flight control related information, such as, but not limited to, altitude, heading, airspeed, radar data, maps, flight paths, and the like. One or more of the displays 206, 208, 210 can be a touchscreen that allows pilot interaction for arranging the flight control related information and/or otherwise impacting the operation of the aircraft 100. Also in response to the selection of the piloted mode of operation, the ceiling displays 212, 214, 216 may default to displaying video provided by the upwardly directed camera 202 to give the passengers the visual sense of a ceiling window. Of course, as explained above, one or more of the displays 206, 208, 210, 212, 214, 216 may be controlled (such as by direct touchscreen user inputs) to display something besides the above-described default display content of the piloted display mode.

In another example, a selection may be made to operate the aircraft 100 in an autonomous mode of operation. Accordingly, the display system 200 may operate in an autonomous display mode. In the autonomous display mode, each of the left display 208 and right display 210 can be automatically configured to display flight control related information, such as, but not limited to, altitude, heading, airspeed, radar data, maps, flight paths, and the like. In the autonomous display mode, the center display 206 can automatically display personalized content specific to the passenger sitting in the pilot seat 122. For example, the center display 206 can display interactive content, such as, but not limited to, email, social media content, news, and/or the like. Also in response to the selection of the autonomous mode of operation, the ceiling displays 212, 214, 216 may default to displaying video provided by the upwardly directed camera 202 to give the passengers the visual sense of a ceiling window. Of course, as explained above, one or more of the displays 206, 208, 210, 212, 214, 216 may be controlled (such as by direct touchscreen user inputs) to display something besides the above-described default display content of the autonomous display mode. For example, since the passenger in the pilot seat 122 is not actively commanding the aircraft 100, one or more of the displays 206, 208, 210 can be commanded to display video provided by the forward directed camera 204 to give the passenger in the pilot seat 122 the sense of looking through windows to the environment around the aircraft 100.

It will be appreciated that any of the displays can be configured to selectively display any available content, but that, in some embodiments, the displays may initially be programmed to display content as a function of the mode (piloted or autonomous) in which the aircraft 100 is being controlled.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A display system for an aircraft, comprising:
a plurality of displays, wherein the displays are configured to display a predetermined content in response to which of a piloted mode and an autonomous mode the aircraft is operating.

2. The display system of claim 1, further comprising:
a display associated with a pilot seat; and
a ceiling display.

3. The display system of claim 2, wherein when the aircraft is operating in the piloted mode, the display associated with the pilot seat displays flight control information.

4. The display system of claim 2, wherein when the aircraft is operating in the autonomous mode, the display associated with the pilot seat displays environmental video obtained from a camera.

5. The display system of claim 2, wherein when the aircraft is operating in the autonomous mode, the display associated with the pilot seat displays information specific to a user seated in the pilot seat.

6. The display system of claim 2, wherein the ceiling display displays environmental video obtained from a camera.

7. The display system of claim 6, wherein the environmental video is video of an environment above the ceiling.

8. A display system for an aircraft, comprising:
a plurality of displays associated with a pilot seat, wherein the displays are configured to display a predetermined content in response to which of a piloted mode and an autonomous mode the aircraft is operating.

9. The display system of claim 8, wherein when the aircraft is operating in the piloted mode, at least one of the displays associated with the pilot seat displays flight control information.

10. The display system of claim 8, wherein when the aircraft is operating in the autonomous mode, at least one of the displays associated with the pilot seat displays environmental video obtained from a camera and at least one of the displays associated with the pilot seat displays flight control information.

11. The display system of claim 8, wherein when the aircraft is operating in the autonomous mode, at least one of the displays associated with the pilot seat displays information specific to a user seated in the pilot seat and at least one of the displays associated with the pilot seat displays flight control information.

12. The display system of claim 8, wherein when the aircraft is operating in the autonomous mode, at least one of the displays associated with the pilot seat displays information specific to a user seated in the pilot seat and at least one of the displays associated with the pilot seat displays environmental video obtained from a camera.

13. An aircraft, comprising:
a fuselage having a ceiling;
a pilot seat disposed in the fuselage; and
a plurality of displays, wherein the displays are configured to display a predetermined content in response to which of a piloted mode and an autonomous mode the aircraft is operating.

14. The display system of claim 13, further comprising:
a display associated with a pilot seat; and
a ceiling display.

15. The display system of claim 14, wherein when the aircraft is operating in the piloted mode, the display associated with the pilot seat displays flight control information.

16. The display system of claim 14, wherein when the aircraft is operating in the autonomous mode, the display associated with the pilot seat displays environmental video obtained from a camera.

17. The display system of claim 14, wherein when the aircraft is operating in the autonomous mode, the display associated with the pilot seat displays information specific to a user seated in the pilot seat.
